(19) United States
(12) Patent Application Publication
(10) Pub. No.: US 2014/0205991 A1
(43) Pub. Date: Jul. 24, 2014

(54) SYSTEM AND METHOD FOR PROVIDING TEACHING-LEARNING MATERIALS CORRESPONDING TO REAL-WORLD SCENARIOS

(71) Applicant: Quanta Computer Inc., Kuei Shan Hsiang (TW)

(72) Inventors: Yushi Xu, Kuei Shan Hsiang (TW); Kang-Wen Lin, Kuei Shan Hsiang (TW)

(73) Assignee: Quanta Computer Inc., Kuei Shan Hsiang (TW)

(21) Appl. No.: 14/083,947

(22) Filed: Nov. 19, 2013

(30) Foreign Application Priority Data
Jan. 23, 2013 (TW) 102102415

(51) Int. Cl. G09B 5/08

(52) U.S. Cl. CPC G09B 5/08
USPC 434/362

(57) ABSTRACT

A method is provided for providing teaching-learning materials corresponding to real-world scenarios. Teaching-learning materials are provided and stored in advance, wherein each item of the teaching-learning materials corresponds to coordinates marking locations for at least one landmark. A service request specifying the coordinates of a location for a specific client device is received. One item of the teaching-learning materials is then selected in response to the service request, wherein the selected teaching-learning material corresponding to the landmark that is located on or near the location of the client device. Learning service is provided based on the selected teaching-learning material.

### CROSS REFERENCE TO RELATED APPLICATIONS

This application claims priority of Taiwan Patent Application Ser. No. 102102415, filed Jan. 1, 2013, entitled SYSTEM AND METHOD FOR PROVIDING TEACHING-LEARNING MATERIALS CORRESPONDING TO REAL-WORLD SCENARIOS. The contents of this application are hereby incorporated by reference.

### BACKGROUND OF THE INVENTION

1. Field of the Invention

The present invention relates to a distance education system, and in particular, to a system and method for providing teaching-learning materials corresponding to real-world scenarios according to geographic information corresponding to a learner.

2. Description of the Related Art

According to a traditional classroom teaching method, teaching-learning materials and testing materials are delivered to learners by teachers in a restricted environment (such as a classroom). For example, the teacher explains the basic alphabet and grammar rules, and repeated pronunciation practice is conducted for a word or a sentence. In order to ensure that all learners in class review on their own after school, the teacher normally conducts a variety of tests and classroom exams.

Recently, language teaching software has been provided to deliver course material. The language teaching software implements a process similar to the traditional classroom teaching method. For example, course materials are generated and recorded in the language teaching software in advance. In addition to textbooks, language teaching software also delivers interactive courses for assessing and testing students in a virtual environment.

Both the classroom teaching method and the language teaching software delivers course material having contents that are organized in a predetermined order. Accordingly, learners can only passively receive predetermined course material.

The traditional classroom teaching method and language teaching software cannot provide a real and interesting learning experience to learners. In addition, the traditional classroom teaching method and language teaching software cannot enhance learning results through a learner's real experience.

Accordingly, there is a need for a system and method that can deliver teaching-learning materials in accordance with a real-world environment in which the learner is situated, and thus providing a real and interesting learning experience to learners.

### BRIEF SUMMARY OF THE INVENTION

A detailed description is given in the following embodiments with reference to the accompanying drawings.

In an exemplary embodiment, a method for providing teaching-learning materials corresponding to a real-world scenario is provided. The method has the steps of: storing teaching-learning materials, wherein each of the teaching-learning material corresponds to the landmark location coordinates of at least one landmark; receiving a teaching service request from a client device, wherein the teaching service request specifies client location coordinates corresponding to the client device; determining one of the stored teaching-learning materials as a selected teaching-learning material, wherein the selected teaching-learning material corresponds to landmark location coordinates close to the client location coordinates; and providing, in response to the received teaching service request, teaching service to the client device according to the selected teaching-learning material.

In the above method, the landmark location coordinates are GPS (Global Positioning System) information specifying the geographical location of a landmark, and the client location coordinates are GPS information specifying the geographical location of the client device.

In the above method, the teaching-learning material further corresponds to time-of-day information and/or season information. The method further comprises: determining the selected teaching-learning material according to a time at which the teaching service request is received, wherein the time-of-day information or the season information of the selected teaching-learning material corresponds to the time at which the teaching service request is received.

In the above method, the teaching-learning material is used for delivering language education. The teaching-learning material further comprises language courses pertaining to the landmark. The method further comprises the step of delivering the language course pertaining to the landmark according to the teaching-learning material.

In another exemplary embodiment, a system for providing teaching-learning materials corresponding to a real-world scenario is provided. The system has the following elements: a storage device for storing teaching-learning materials, wherein each of the teaching-learning materials corresponds to the landmark location coordinates of at least one landmark; an input-output interface for receiving a teaching service request from a client device, wherein the teaching service request specifies client location coordinates corresponding to the client device; and a processing device for determining one of the stored teaching-learning materials as a selected teaching-learning material, wherein the selected teaching-learning material corresponds to landmark location coordinates close to the client location coordinates. In addition, the processing device provides, in response to the received teaching service request, teaching service to the client device according to the selected teaching-learning material.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating a system for providing teaching-learning materials corresponding to a real-world scenario according to an embodiment of the invention;

FIG. 2 shows a lookup table according to an embodiment of the invention;

FIG. 3 is a flowchart illustrating the method for providing teaching-learning materials corresponding to a real-world scenario according to an embodiment of the invention;

FIG. 4A illustrates part of a graphical user interface display of an electronic device according to an embodiment of the invention; and

FIG. 4B illustrates part of a graphical user interface display of an electronic device according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

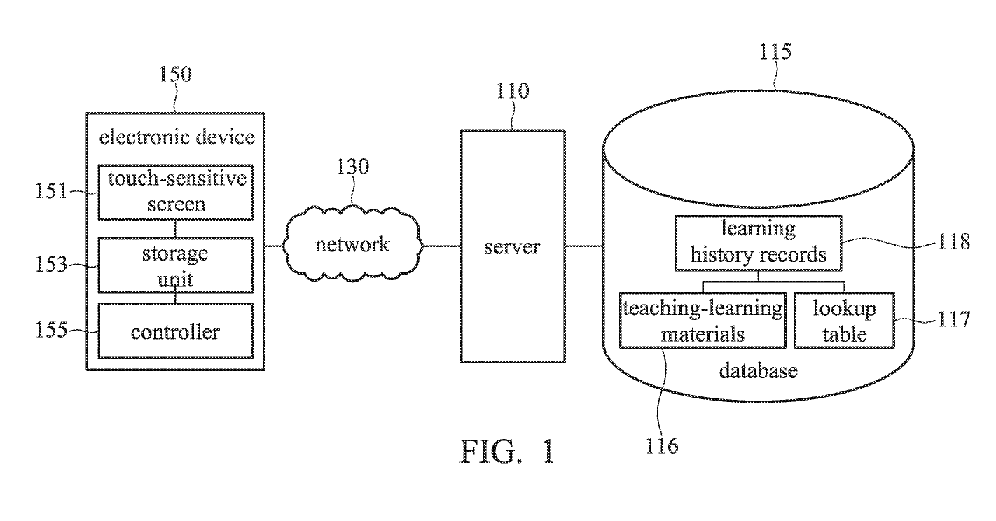

FIG. 1 is a schematic diagram illustrating a system for providing teaching-learning materials corresponding to a real-world scenario according to an embodiment of the invention. In order to provide a concise explanation of the present invention, only elements substantially pertaining to providing teaching-learning materials are illustrated in FIG. 1. In the electronic device 150 and server 110, elements which are not substantially pertaining to the providing teaching-learning materials are omitted.

The electronic device 150 can be a personal computer or portable electronic device, such as a PDA (Personal Digital Assistant), a mobile phone, a smart phone, or a mobile Internet Device (MID).

The electronic device 150 comprises a touch-sensitive screen 151, a storage unit 153, and a controller 155. Using the touch-sensitive screen 151, a user can utilize the method of providing teaching-learning materials corresponding to a real-world scenario in a more intuitive way. The touch-sensitive screen 151 is not intended to limit the invention. In another exemplary embodiment, the electronic device 150 uses a traditional input/output module, such as a keyboard to implement the method of the present invention, rather than the touch-sensitive screen 151.

The touch-sensitive screen 151 can display related graphics, data, and interfaces. The touch-sensitive screen 151 receives inputs corresponding to user manipulation, and transmits the received inputs to the controller 155 for further processing.

The storage unit 153 stores personal data, settings and software of the electronic device 150.

The controller 155 controls the electronic device 150, processes data input by a user, and controls the operations of a Network Interface Card (NIC) and other hardware to implement Network connection and GPS localization in the electronic device 150. For example, the controller 155 can be implemented by a processor.

The electronic device 150 connects to server 110 through a network 130.

The server 110, which can be a general computer, is connected to a database 115. The server 110 provides teaching-learning materials corresponding to a real-world scenario according to GPS information and other data transmitted from the electronic device 150.

Teaching-learning materials 116 are prepared in advance and stored in the database 115. The teaching-learning materials 116 can comprise voice data, image data and text data corresponding to a particular landmark. Contents of the teaching-learning materials 116 can be designed and generated to meet requirements. In order to facilitate the utilization of the teaching-learning materials 116, a lookup table 117 can be generated and stored in the database 115, thus the teaching-learning materials 116 can be screened and used according to different criteria. In addition, assessment results and other learning history records 118 corresponding to each particular learner can be stored in the database 115, thus assessment can be implemented for each particular learner.

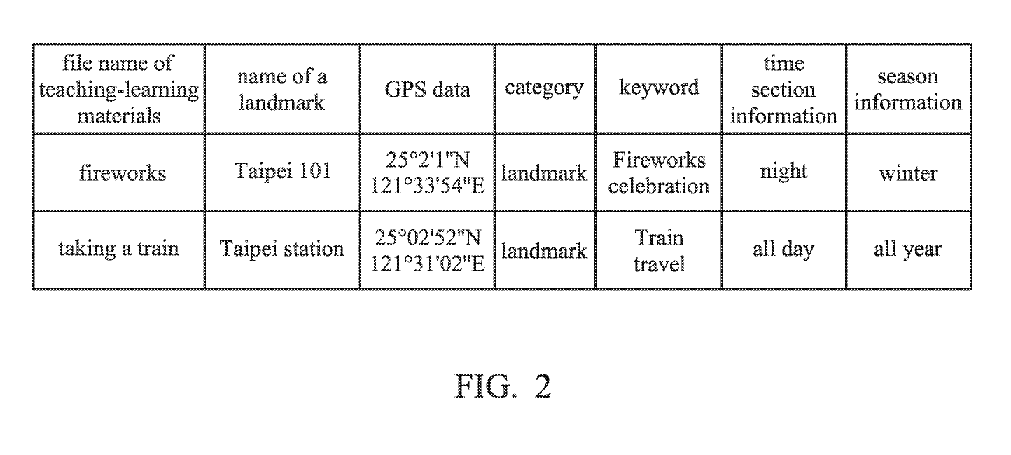

For example, referring to FIG. 2, in lookup table 117, ‘file name of teaching-learning materials’ and corresponding information, such as ‘name of a landmark’, ‘GPS data’, ‘category’, ‘keyword’, ‘time section information’, and ‘season information’, are stored. According to this embodiment, each of the teaching-learning materials 116 is given a particular file name, and each of the teaching-learning materials 116 corresponds to at least one real-world landmark. In the field of ‘GPS data’, GPS data of the landmark corresponding to the teaching-learning materials 116 is recorded. In the field of ‘category’, a category of the landmark corresponding to the teaching-learning materials 116 is recorded. For example, the landmarks can be divided into categories such as ‘Amusements, Rides and Theme Parks’, ‘Art Museums and Galleries’, ‘Financial Centers, Mints, Markets’, ‘Government’, ‘Shopping Centers’, ‘Skyscrapers’, etc. In the field of ‘keyword’, at least one keyword contained in the teaching-learning materials 116 is recorded. In the field of ‘time section information’, time section, such as morning, noon, afternoon or night, during which the teaching-learning materials 116 might be suitably applied is recorded. In the field of ‘season information’, the season, such as spring, summer, fall or winter, during which the teaching-learning materials 116 might be suitably applied, is recorded.

For example, FIG. 2 illustrates a lookup table with one teaching-learning material file per row. In the first row, a file named ‘fireworks’, as well as information corresponding to this file, are recorded. In the first row of the lookup table, ‘fireworks’ is recorded in the field of ‘file name of teaching-learning materials’; ‘Taipei 101 building’ is recorded in the field of ‘name of a landmark’; ‘25° 2′1″N, 121° 33′24″E’, i.e., GPS information of the landmark ‘Taipei 101 building’ is recorded in the field of ‘GPS data’; ‘Skyscrapers’ is recorded in the field of ‘category’ of the landmark ‘Taipei 101 building’; ‘fireworks’ and ‘celebration’ are recorded in the field of ‘keyword’; ‘night’ is recorded in the field of ‘time section information’; ‘winter’ is recorded in the field of ‘season information’.

For another example, referring to the lookup table illustrated in FIG. 2. In the second row, the file named ‘taking a train’, as well as information corresponding to this file, are recorded. In the second row of the lookup table, ‘taking a train’ is recorded in the field of ‘file name of teaching-learning materials’; ‘Taipei station’ is recorded in the field of ‘name of a landmark’; ‘25° 02′52″N, 121° 31′02″E’, i.e., GPS information of the landmark ‘Taipei station’ is recorded in the field of ‘GPS data’; ‘transportation’ is recorded in the field of ‘category’ of the landmark ‘Taipei station’; ‘train’ and ‘travel’ are recorded in the field of ‘keyword’; ‘all day’ is recorded in the field of ‘time section information’; ‘all year’ is recorded in the field of ‘season information’.

In addition, each of the teaching-learning materials 116 corresponds to one or more landmark(s). Using the teaching-learning material named ‘fireworks’ as an example, the corresponding landmarks can include landmarks other than ‘Taipei 101 building’, such as ‘Tamsui River side’ or ‘Tokyo Tower’, etc. Similarly, for the teaching-learning material named ‘taking a train’, the corresponding landmarks can include landmarks other than ‘Taipei station’, such as ‘Taichung’ or ‘Tokyo Station’, etc. For each real-world landmark, corresponding ‘GPS data’, ‘category’, ‘keyword’, ‘time section information’, and ‘season information’ are stored.

According to an embodiment, when a plurality of landmarks are presented in response to a teaching service request, landmarks located at positions close to the client location coordinates of the client device issuing the teaching service request are presented first. For example, when the client device is located close to Taipei station, the landmarks in the vicinity are presented, such as Wanhua station and Songshan station. On the other hand, landmarks which are not in the vicinity will not be presented or will come after the nearby landmarks on the list.

The server 110 provides the teaching service to the electronic device 150 according to contents stored in the database 115. Interaction between the server 110 and the electronic device 150 is described in the following.

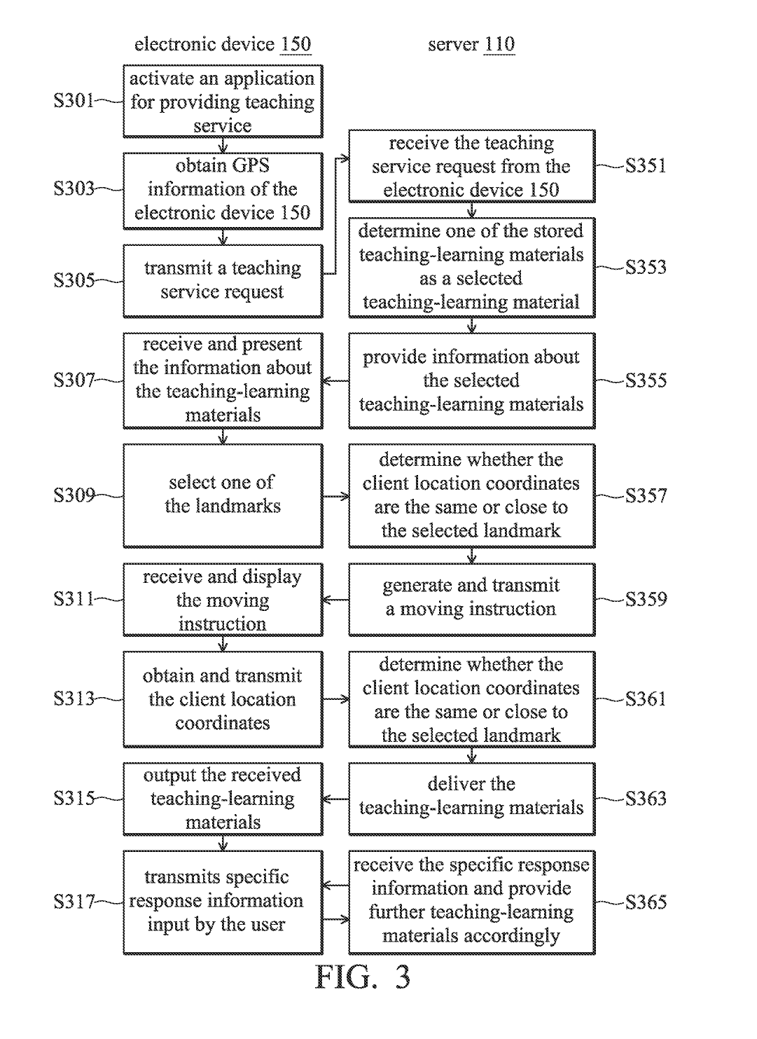

FIG. 3 is a flowchart illustrating the method for providing teaching-learning materials corresponding to a real-world scenario according to an embodiment of the invention.

The method illustrated in FIG. 3 can be implemented in the server 110, electronic device 150, and database 115 of FIG. 1.

While the process flow described below includes a number of operations that appear to occur in a specific order, it should be apparent that these processes may include more or fewer operations, which may be executed serially or in parallel (for example, using parallel processors or a multi-threading environment).

In step S301, an application for providing teaching service is activated. After the activation, the method proceeds to step S303, GPS information (hereinafter referred to as the client location coordinates) of the electronic device 150 is obtained by using a GPS device equipped in the electronic device 150.

In step S305, a teaching service request is transmitted from the electronic device 150 to the server 110. The client location coordinates obtained in step S303 is contained in the teaching service request.

In the step S351, the server 110 receives the teaching service request (along with the client location coordinates) transmitted from the electronic device 150.

In step S353, the server 110 performs a search in the database 115 in order to determine one of the stored teaching-learning materials as a selected teaching-learning material, wherein the selected teaching-learning material corresponds to landmark location coordinates close to (i.e., within a predetermined distance) the client location coordinates. The predetermined distance can be determined to meet certain requirements. For example, the predetermined distance can be a distance equal to or larger than 0. When the predetermined distance is 0, the electronic device 150 is positioned at the location of the landmark.

For example, utilizing the lookup table illustrated in FIG. 2, the server 110 selects a teaching-learning material file corresponding to a position (specified in the GPS data field) within the predetermined distance from the position of the client device (specified by the client location coordinates).

In step S355, the server 110 provides information about the selected teaching-learning materials to the electronic device 150.

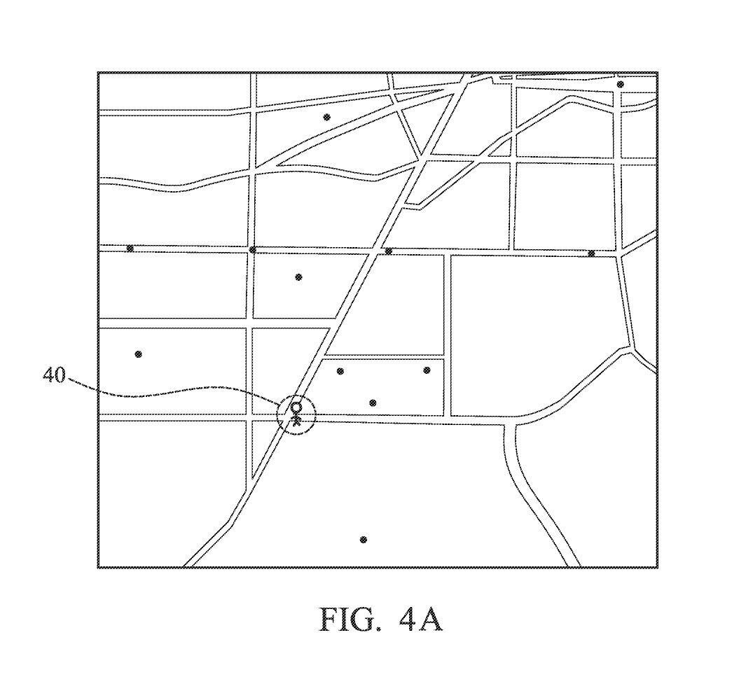

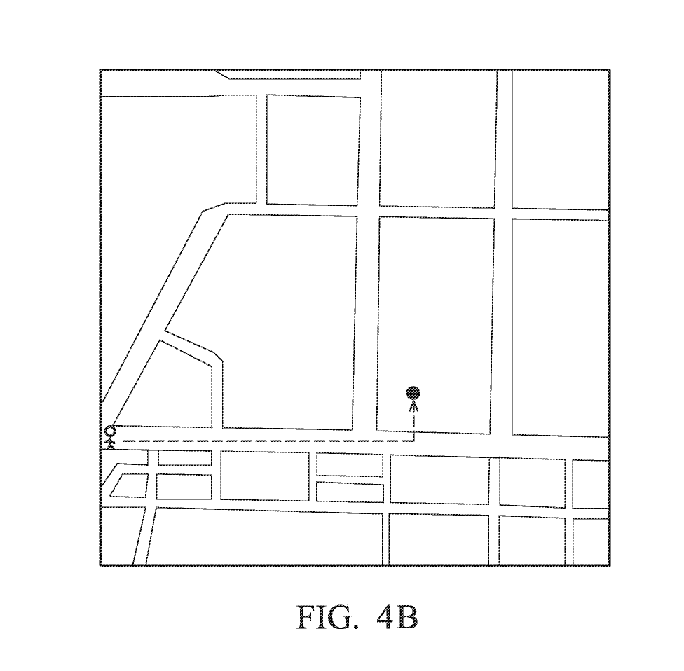

In step S307, the electronic device 150 receives the information about the teaching-learning materials transmitted by the server 110, and then presents the received information on a screen. According to this embodiment, the received information about the teaching-learning materials contains ‘file name of teaching-learning materials’ and corresponding ‘name of a landmark’. This information can be presented on a list (not shown) or on a map (as shown in FIG. 4A).

Referring to FIG. 4A, a user (electronic device 150) stands at a location marked by mark 40. In addition, several spots are presented in FIG. 4A, wherein each of the spot represents a landmark having corresponding teaching-learning materials. As shown in FIG. 4A, there is no corresponding teaching-learning material at the position at which the user is standing.

In step S309, one of the spots (i.e., landmarks) illustrated in FIG. 4A is selected by the user. A message recording this selection result is then sent to the server 110.

In step S357, the server 110 determines whether the current location of the user (client location coordinates) is the same or close to the location of the selected landmark. A predetermined distance can be set as a definition of ‘close to the location of the selected landmark’. For example, the predetermined distance can be set as 10 meters. In other words, when the distance between the current location of the user and the location of the selected landmark is 10 meters or less than 10 meters, it is determined the current location of the user and the location of the selected landmark is close. The predetermined distance is not limited to 10 meters, and can be adjusted to meet requirement.

According to this embodiment, in step S357, if it is determined that the current location of the user and the location of the selected landmark are far (not close), then the method proceeds to step S359. In step S359, a moving instruction is generated and transmitted to the electronic device 150. On the other hand, in step S357, if it is determined the current location of the user and the location of the selected landmark are close (or the same), then the method proceeds to step S363. In step S363, teaching-learning materials are delivered to the electronic device 150.

In step S311, the electronic device 150 receives the moving instruction from server 110, and displays the received moving instruction on screen. For example, the electronic device 150 displays a line with an arrow on the map illustrated in FIG. 4A in order to present the received moving instruction. In this embodiment, the selected landmark is ‘Taipei 101 building’, and the line with an arrow illustrated in FIG. 4B represents a path by which the user can get to the selected landmark from his or her current location.

In step S313, while the user is moving according to the moving instruction, the client location coordinates of the electronic device 150 are obtained and transmitted to the server 110. According to this embodiment, the client location coordinates of the electronic device 150 are obtained and transmitted periodically from the electronic device 150 to the server 110.

In step S361, the server 110 determines whether the current location of the user (client location coordinates) is the same or close to the location of the selected landmark.

In step S361, it is determined that the current location of the user and the location of the selected landmark are close (or the same), and the method proceeds to step S363. In step S363, teaching-learning materials are delivered to the electronic device 150.

In step S315, the electronic device 150 outputs (displays or plays) the received teaching-learning materials. In step S317, the electronic device 150 transmits specific response information input by the user to the server 110. In step S365, the server 110 receives the specific response information and provides further teaching-learning materials accordingly.

Detailed operations and information transmitted in steps S363˜S365 and steps 315˜317 vary according to the contents of the corresponding teaching-learning materials. For example, a particular file of teaching-learning materials can request the user to complete specific assignments, answer questions, and so on. For example, according to this embodiment, the teaching-learning materials ask the user to take a photograph of the selected landmark (i.e., the Taipei 101 building); to read out words, phrases, or sentences written in the teaching-learning materials; or to answer questions stated in the teaching-learning materials.

The specific response information, such as a photograph, can be stored in the server for further analysis or assessment.

In addition, a particular landmark can correspond to several files of the teaching-learning materials, and the server 110 can provide a different file of the teaching-learning materials corresponding to a particular landmark according to the time at which a teaching service request is received. For example, when the teaching service request is received during the daytime, teaching-learning materials relating to the observatory of Taipei 101 building can be provided.

In addition, the server 110 can provide a different file of teaching-learning materials corresponding to a particular landmark according to season at which a teaching service request is received. For example, when the teaching service request is received around summer, teaching-learning materials relating to an activity named ‘Taipei 101 Run up’ can be provided.

According to an embodiment, in step S305, a teaching service request is transmitted together with a keyword of teaching-learning materials. In step S353, teaching-learning materials corresponding to the designated keyword are selected, and landmarks corresponding to the selected teaching-learning materials are presented. In another embodiment, a landmark closest to the current client location coordinates is selected and corresponding teaching-learning materials are delivered.

In yet another embodiment, the moving instruction received in step S311 can be implemented by Augmented Reality (AR) and displayed on the touch-sensitive screen 151.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for providing teaching-learning materials corresponding to a real-world scenario, comprising:
storing teaching-learning materials, wherein each of the teaching-learning material corresponds to landmark location coordinates of at least one landmark;
receiving a teaching service request from a client device, wherein the teaching service request specifies client location coordinates corresponding to the client device;
determining one of the stored teaching-learning materials as a selected teaching-learning material, wherein the selected teaching-learning material corresponds to landmark location coordinates close to the client location coordinates; and
providing, in response to the received teaching service request, teaching service to the client device according to the selected teaching-learning material.

2. The method of claim 1, wherein the teaching-learning material further corresponds to at least one of time-of-day information and season information, wherein the method further comprises:
determining the selected teaching-learning material according to a time at which the teaching service request is received, wherein the time-of-day information or the season information of the selected teaching-learning material corresponds to the time.

3. The method of claim 1, wherein the teaching-learning material is used for delivering language education.

4. The method of claim 3, wherein the teaching-learning material further comprises a language course pertaining to the landmark, the method further comprises:
delivering the language course pertaining to the landmark according to the teaching-learning material.

5. The method of claim 4, further comprising:
transmitting an action request to the client device according to the teaching-learning material, for requiring the client device to return specific response information; and
in response to receiving the specific response information, storing the received specific response information for further use, wherein the specific response information comprises at least one of the following: a photograph, voice data, and text.

6. A system for providing teaching-learning materials corresponding to a real-world scenario, comprising:
a storage device, storing teaching-learning materials, wherein each of the teaching-learning material corresponds to landmark location coordinates of at least one landmark;
an input-output interface, receiving a teaching service request from a client device, wherein the teaching service request specifies client location coordinates corresponding to the client device; and
a processing device, determining one of the stored teaching-learning materials as a selected teaching-learning material, wherein the selected teaching-learning material corresponds to landmark location coordinates close to the client location coordinates, and providing, in response to the received teaching service request, teaching service to the client device according to the selected teaching-learning material.

7. The system of claim 6, wherein:
the teaching-learning material stored in the storage device further corresponds to at least one of time-of-day information and season information; and
the processing device determines the selected teaching-learning material according to a time at which the teaching service request is received, wherein the time-of-day information or the season information of the selected teaching-learning material corresponds to the time.

8. The system of claim 6, wherein the teaching-learning material is used for delivering language education.

9. The system of claim 8, wherein:
the teaching-learning material stored in the storage device further comprises language course pertaining to the landmark; and
the processing device delivers the language course pertaining to the landmark according to the teaching-learning material.

10. The system of claim 9, wherein the processing device further executes the steps of:
transmitting an action request to the client device according to the teaching-learning material, for requiring the client device to return specific response information; and
in response to receiving the specific response information, storing the received specific response information for further use, wherein the specific response information comprises at least one of the following: a photograph, voice data, and text.
